(19) United States
(12) Patent Application Publication
(10) Pub. No.: US 2023/0397517 A1
(43) Pub. Date: Dec. 14, 2023

(54) WORK MACHINE REVERSE PASSIVE IMPLEMENT GUIDANCE SYSTEM AND METHOD

(71) Applicant: Deere & Company, Moline, IL (US)

(72) Inventor: Joshua T. Lawson, Woodbury, MN (US)

(21) Appl. No.: 17/835,501

(22) Filed: Jun. 8, 2022

(51) Int. Cl. A01B 69/08; A01B 69/04

(52) U.S. Cl. CPC A01B 69/006; A01B 69/008

(57) ABSTRACT

A reverse passive implement guidance system is provided for a work machine having a work vehicle configured to direct an implement coupled to the work vehicle via a steering system along a desired implement path. The reverse passive implement guidance system includes one or more vehicle sensors to collect vehicle position and orientation information; one or more implement sensors to collect implement position and orientation information; a controller coupled to the one or more vehicle sensors and the one or more implement sensors. The controller is configured to: receive the vehicle position and orientation information and the implement position and orientation; generate vehicle steering commands to drive the work vehicle such the implement is guided in a reverse direction onto or along the desired implement path; and execute the vehicle steering commands via the steering system of the work vehicle.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

The present disclosure relates to a control arrangement of a work machine, particularly to a reverse passive implement guidance system and method to control a vehicle during operation in a reverse direction such that the implement is maneuvered towards or maintains a desired path.

### BACKGROUND OF THE DISCLOSURE

A work machine may include a work vehicle that tows an implement to perform various tasks. For example, a tractor may tow an agricultural implement, such as a tiller or planter. While guidance system to maintain a desired path exist for the vehicle, placement of the implement performing the work task is more critical. Such implement guidance may be challenging, particularly in the reverse direction.

### SUMMARY OF THE DISCLOSURE

The disclosure provides a reverse passive implement guidance system and method that facilitates operation of a work vehicle.

In one aspect, the disclosure provides a reverse passive implement guidance system for a work machine having a work vehicle configured to direct an implement coupled to the work vehicle via a steering system of the work vehicle along a desired implement path. The reverse passive implement guidance system includes one or more vehicle sensors mounted on the work vehicle to collect vehicle position and orientation information associated with the work vehicle; one or more implement sensors mounted on the implement to collect implement position and orientation information associated with the implement; a controller coupled to the one or more vehicle sensors and the one or more implement sensors. The controller has a processor and memory architecture configured to: receive the vehicle position and orientation information and the implement position and orientation; generate vehicle steering commands based on vehicle position and orientation information and the implement position and orientation to drive the work vehicle such the implement is guided in a reverse direction onto or along the desired implement path; and execute the vehicle steering commands via the steering system of the work vehicle.

In a further aspect, the controller of the reverse passive implement guidance system is configured to generate the vehicle steering commands based on a system curvature of the work machine.

In a further aspect, the controller of the reverse passive implement guidance system is configured to generate the vehicle steering commands with closed loop and feed forward control mechanisms.

In a further aspect, the controller of the reverse passive implement guidance system is configured to generate the vehicle steering commands with a machine efficacy value.

In a further aspect, the controller of the reverse passive implement guidance system is configured to generate the vehicle steering commands limited according to a jackknife angle.

In a further aspect, the controller of the reverse passive implement guidance system is configured to generate the vehicle steering commands based on a system curvature of the work machine in which the system curvature is defined as a curvature between a front vehicle wheel reference line and an implement reference line within a stable system.

In a further aspect, the controller of the reverse passive implement guidance system is configured to generate the vehicle steering commands by generating a system curvature command based on implement lateral and heading errors.

In a further aspect, the controller of the reverse passive implement guidance system is configured to generate the vehicle steering commands further by: transforming the system curvature command into a first vehicle-implement angle command as a closed loop control mechanism; determining an implement path curvature and transforming the implement path curvature into a second vehicle-implement angle command as a feed forward control mechanism; and combining the first vehicle-implement angle command and the second vehicle-implement angle command to generate an initial vehicle-implement angle command.

In a further aspect, the controller of the reverse passive implement guidance system is configured to generate the vehicle steering commands further by limiting the initial vehicle-implement angle command by a jackknife angle to generate a limited vehicle-implement angle command.

In a further aspect, the controller of the reverse passive implement guidance system is configured to generate the vehicle steering commands further by: subtracting a current vehicle-implement angle from the limited vehicle-implement angle command to generate a vehicle-implement angle error; transforming the vehicle-implement angle error into an initial vehicle curvature command; scaling the initial vehicle curvature command by application of an efficacy value to generate a closed loop vehicle curvature command; transforming the current implement angle into a feed forward vehicle curvature command by maintaining a zero relative yaw rate; and combining the closed loop vehicle curvature command and the feed forward vehicle curvature command to generate a final vehicle curvature command that is executed as the steering commands.

In another aspect, the disclosure provides a work machine with a work vehicle having a steering system; an implement coupled to the work vehicle and configured to be manipulated by the work vehicle; and a reverse passive implement guidance system for the work vehicle configured to direct the implement via the steering system of the work vehicle along a desired implement path. The reverse passive implement guidance system includes one or more vehicle sensors mounted on the work vehicle to collect vehicle position and orientation information associated with the work vehicle; one or more implement sensors mounted on the implement to collect implement position and orientation information associated with the implement; and a controller coupled to the one or more vehicle sensors and the one or more implement sensors, the controller having a processor and memory architecture configured to: receive the vehicle position and orientation information and the implement position and orientation; generate vehicle steering commands based on vehicle position and orientation information and the implement position and orientation to drive the work vehicle such the implement is guided in a reverse direction onto or along the desired implement path; and execute the vehicle steering commands via the steering system of the work vehicle.

In a further aspect, the controller of the reverse passive implement guidance system of the work machine is configured to generate the vehicle steering commands based on a system curvature of the work machine.

In a further aspect, the controller of the reverse passive implement guidance system of the work machine is configured to generate the vehicle steering commands with closed loop and feed forward control mechanisms.

In a further aspect, the controller of the reverse passive implement guidance system of the work machine is configured to generate the vehicle steering commands with a machine efficacy value.

In a further aspect, the controller of the reverse passive implement guidance system of the work machine is configured to generate the vehicle steering commands limited according to a jackknife angle.

In a further aspect, the controller of the reverse passive implement guidance system of the work machine is configured to generate the vehicle steering commands based on a system curvature of the work machine in which the system curvature is defined as a curvature between a front vehicle wheel reference line and an implement reference line within a stable system.

In a further aspect, the controller of the reverse passive implement guidance system of the work machine is configured to generate the vehicle steering commands by generating a system curvature command based on implement lateral and heading errors.

In a further aspect, the controller of the reverse passive implement guidance system of the work machine is configured to generate the vehicle steering commands further by: transforming the system curvature command into a first vehicle-implement angle command as a closed loop control mechanism; determining an implement path curvature and transforming the implement path curvature into a second vehicle-implement angle command as a feed forward control mechanism; and combining the first vehicle-implement angle command and the second vehicle-implement angle command to generate an initial vehicle-implement angle command.

In a further aspect, the controller of the reverse passive implement guidance system of the work machine is configured to generate the vehicle steering commands further by limiting the initial vehicle-implement angle command by a jackknife angle to generate a limited vehicle-implement angle command.

In a further aspect, the controller of the reverse passive implement guidance system of the work machine is configured to generate the vehicle steering commands further by: subtracting a current vehicle-implement angle from the limited vehicle-implement angle command to generate a vehicle-implement angle error; transforming the vehicle-implement angle error into an initial vehicle curvature command; scaling the initial vehicle curvature command by application of an efficacy value to generate a closed loop vehicle curvature command; transforming the current implement angle into a feed forward vehicle curvature command by maintaining a zero relative yaw rate; and combining the closed loop vehicle curvature command and the feed forward vehicle curvature command to generate a final vehicle curvature command that is executed as the steering commands

The details of one or more embodiments are set forth in the accompanying drawings and the description below. Other features and advantages will become apparent from the description, the drawings, and the claims.

### BRIEF DESCRIPTION OF THE DRAWINGS

FIG. 1 is a top schematic view of a work machine as a work vehicle and implement in which a reverse passive implement guidance system may be implemented according to an example embodiment;

FIGS. 2A and 2B are collectively a flowchart of one implementation the reverse passive implement guidance system of FIG. 1 according to an example embodiment; and

FIG. 3 is a schematic diagram depicting aspects of the reverse passive implement guidance system of FIG. 1 according to an example embodiment; and

FIG. 4 is a schematic diagram depicting aspects of the reverse passive implement guidance system of FIG. 1 according to an example embodiment.

Like reference symbols in the various drawings indicate like elements.

### DETAILED DESCRIPTION

The following describes one or more example embodiments of the disclosed reverse passive implement guidance system, method, or work machine, as shown in the accompanying figures of the drawings described briefly above. Various modifications to the example embodiments may be contemplated by one of skill in the art.

In the agriculture, construction, and forestry industries, work machines formed by vehicles towing implements are utilized to perform tasks in various types of environments. For example, a tractor may pull a planter or tiller. Various systems exist to guide the vehicle and/or implement through a work environment in a forward direction. However, such systems are not available for guiding the implement in a reverse direction, particularly in a passive manner (e.g., without independent steering or propulsion at the implement). Independently actuated and/or actively guided implements require expensive modification or upfront costs.

Consideration of implement guidance is particularly applicable in situations in which the implement does not necessary follow the path of the vehicle, such as a side hill situation in which the implement tends to drift down the hill. Misplacement of the implement may cause undesired issues, such as improper placement of agricultural materials, water, and the like. Moreover, implement guidance may be particularly useful in unmanned operation in which the skill of an experienced operator is not available.

According to the present disclosure, a work machine formed by a vehicle and an implement may incorporate a reverse passive implement system (and method) in order to guide the implement onto or along a desired path in a reverse direction. Such a reverse passive implement system may consider “system” curvature in addition to or in lieu of vehicle road wheel angle. Such consideration of system curvature, in addition to the system parameters, enable abstraction away from the particular dimensions of the vehicle and implement. As such, closed loop and feed forward controls structures may be used to generate suitable vehicle steering commands for guidance of the implement across a number of platforms.

The reverse passive implement guidance system additionally considers and incorporates avoidance of a “jackknife” angle in which the vehicle would otherwise be unable to recover. Such conditions are particularly a concern when operating in a reverse direction. Moreover, the reverse passive implement guidance system may consider system dimensions to generate a scaling or efficacy value in order to linearize the steering commands for a more consistent response across different platforms. Additional details regarding the reverse passive implement guidance system will be provided below.

As used herein, directions with regard to work vehicle and/or implement may be referred to from the perspective of an operator seated within the operator cabin, even if such an operator is not present and the work vehicle is being controlled autonomously or remotely. In particular, the reverse direction is a typical reverse direction, e.g., opposite to an intended or primary direction of travel and/or opposite to the primary working direction.

Elements of the work vehicle and/or implement may experience absolute and relative movement and rotation in various directions. Generally, in the discussion below, a longitudinal direction may be considered along the length of the subject element; a lateral direction may be considered from lateral side-to-side of the subject element; and a vertical direction may be considered perpendicular to both the longitudinal and lateral directions. Rotation or pivoting for the work vehicle and/or implement may be additionally referenced as roll and pitch, but particularly yaw, which refers to pivoting about the vertical direction.

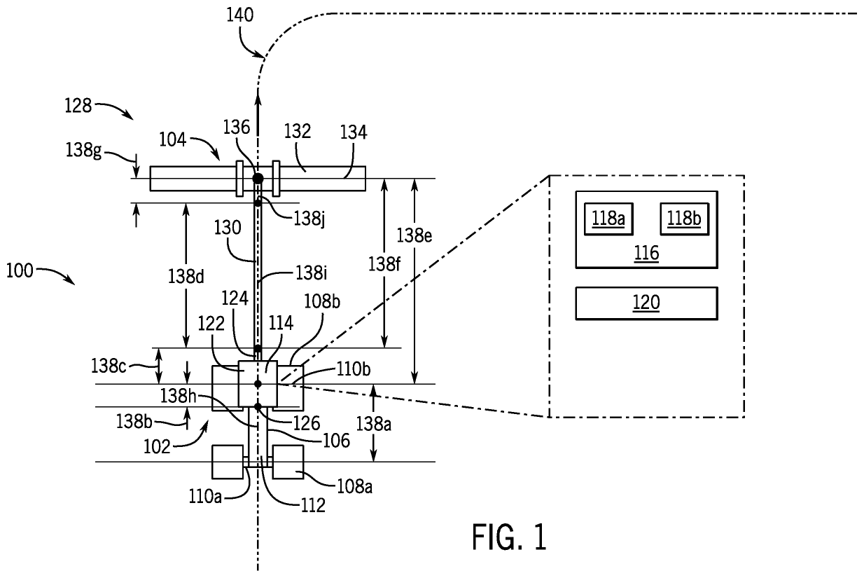

Reference is now made to FIG. 1, which is a top schematic view of work machine 100 made up of a vehicle 102 and an implement 104. Generally, the examples discussed herein are applicable to any type of machine with a vehicle that primarily tows an implement in a primary, forward direction and/or pushes an implement in an alternative, reverse direction. In the depicted example, the vehicle 102 is schematically embodied as a tractor and the implement 104 is schematically imbodied as a tiller. Further examples of implements are plows, harrows, balers, mowers, sprayers, planter, and the like to perform various tasks. Broadly, the vehicle 102 tows the implement 104 along a predetermined path 140 (schematically depicted) in a work, travel, or storage environment in a forward direction and pushes the implement 104 along the predetermined path 140 in a reverse direction, as discussed in greater detail below. The vehicle 102 and implement 104 are coupled together with a hitch 124 and a drawbar 130, either of which may provide a pivot point of the implement 104 relative to the vehicle 102. In this example, the implement 104 is subject to the control of the vehicle 102, particularly in the reverse direction, in that the implement 104 is not independently steered or powered by itself and is pulled, pushed, or directed completely by the power and steering of the vehicle 102.

As described in greater detail below, the work machine 100 with the vehicle 102 and the implement 104 may be operated according to a guidance system, particularly a reverse implement guidance system 128, in which the vehicle 102 is provided with steering commands to maneuver the implement to or along the desired path 140 in the reverse direction. Broadly, reverse guidance is very different than any forward guidance due to the configuration of the machine 100. Additional details about the reverse implement guidance system 128 will be provided below after an introduction of example elements of the vehicle 102 and implement 104.

In one example, the work vehicle 102 includes an undercarriage or chassis 106 that supports the various elements of the vehicle 102. In particular, front and rear wheels 108a, 108b are respectively mounted on front and rear axles 110a, 110b on which the chassis 106 is arranged to support the work vehicle 102 on the ground. One or more of the wheels 108a, 108b may be repositioned by a steering system 112 and powered by a power system 114. The steering system 112 may use any combination of linkages, joints, bearings, and the like to reposition one or more of the wheels 108a, 108b as necessary or desired. Moreover, the power system 114 typically includes an engine or motor, as well as suitable power transmission and accessory components, to drive one or more of the wheels 108a, 108b.

A controller 116 may provide commands to the steering system 112 and power system 114 based on operator commands from an operator in the cabin 122, based on remote operator commands, and/or autonomously based on instructions stored or otherwise accessed by the controller 116 on-board or remotely in order to perform work tasks, including to maneuver through a work environment. As discussed below, the controller 116 may also implement aspects of the reverse implement guidance system 128 to command the work vehicle 102 (e.g., via the steering system 112) such that the implement 104 is maneuvered to or along a desired path 140.

In one example, the work vehicle 102 may include or otherwise interact with a number of sensors (collectively, vehicle kinematic sensors 126), including one or more of a GPS receiver, inertial measurement units (IMUs), cameras, and/or other sensors that provide various parameters to the controller 116 for consideration as part of the reverse passive implement guidance system 128. In particular, the vehicle kinematic sensors 126 may provide vehicle positions and/or orientations (e.g., direction, altitude, etc.), vehicle attitudes (e.g., pitch, roll, yaw), vehicle rates (e.g., speed, yaw rate), and/or angular positions or rates.

In addition to the systems discussed herein, the work vehicle 102 (and/or, in some cases, the implement 104) may include any suitable type of components to carry out appropriate tasks, including hydraulic and electrical systems, braking, communications, and the like.

As noted above, the work implement 104 may be any suitable implement towed (or pushed) by the work vehicle 102 via the hitch 124 and drawbar 130. As also noted, in this example, work implement 104 is a tiller that operates to engage to move or shape the ground or material. Typically, the work implement 104 may be formed by an appropriate tool 132 or other functional elements supported on a frame or chassis, an axle, and wheels to perform the appropriate task. Although not shown in detail, the work implement 104 may be provided with any suitable elements to manipulate the various functional elements (e.g., links, cylinders, controllers, motors, etc.). In this example, the work implement 104 may be considered “passive”, at least with respect to maneuverability and kinematic control along the ground. In other words, the work implement 104 may not have independent steering; and instead, the work implement 104 repositioned by virtue of manipulation by the connections with the work vehicle 102 (e.g., via the hitch 124 and drawbar 130).

In one example, the work implement 104 may include or otherwise interact with a number of sensors (collectively, implement kinematic sensors 136), including one or more of a GPS receiver, inertial measurement units (IMUs), cameras, and/or other sensors that provide various parameters to the controller 116 (e.g., via a bus or communications equipment) for consideration as part of the reverse passive implement guidance system 128. In particular, the kinematic implement sensors 136 may provide implement positions and/or orientations (e.g., direction, altitude, etc.), implement attitudes (e.g., pitch, roll, yaw, etc.), implement rates (e.g., speed, yaw rate, etc.), and/or angular positions or rates.

As noted above, the controller 116 implements operation of the reverse implement guidance system 128, as well as other systems and components of the work vehicle 102, including any of the functions described herein. Such operations may be implemented by the controller 116 housed on the vehicle 102, either autonomously and/or based on commands from an operator at an operator interface 120 arranged within an operator station or cabin 122.

Generally, the controller 116 may be configured as computing devices with associated processor devices and memory architectures, as hydraulic, electrical or electro-hydraulic controllers, or otherwise. In the depicted example, the various functions, including the reverse passive implement guidance system 128 may be implemented within the controller 116 with processing architecture such as a processor 118a and memory 118b, as well as suitable communication interfaces. For example, the controller 116 may implement functional modules or units with the processor 118a based on programs or instructions stored in memory 118b. In some examples, the consideration and implementation of aspects of the reverse passive implement guidance system 128 by the controller 116 are continuous, e.g., constantly active, or at least constantly active when the work machine 100 is operating in the reverse direction. In other examples, the activation may be selective, e.g., enabled or disabled based on input from the operator or other considerations.

As such, the controller 116 may be configured to execute various computational and control functionality with respect to the work vehicle 102 and/or implement 104. The controller 116 may be in electronic, hydraulic, or other communication with various other systems or devices of the work vehicle 102 and/or implement 104, including via a CAN bus (not shown). For example, the controller 116 may be in electronic or hydraulic communication with various actuators, sensors, and other devices within (or outside of) the work vehicle 102 and/or implement 104, as discussed below.

In some embodiments, the controller 116 may be configured to receive input commands and to interface with an operator via the operator interface 120, including typical steering, acceleration, velocity, transmission, and wheel braking controls. The operator interface 120 may be configured in a variety of ways and may include one or more display devices, joysticks, various switches or levers, one or more buttons, a touchscreen interface, a keyboard, a speaker, a microphone associated with a speech recognition system, or various other human-machine interface devices.

The discussion of the reverse passive implement guidance system 128 is provided below with reference to a number of machine parameters and/or dimensions, including at least some of those schematically depicted in FIG. 1. Generally, the center of rotation (or “center”) of the work vehicle 102 may be considered the rear axle 110b, and the center of rotation (or “center”) of the implement 104 may be considered the force center of ground engaging parts (or the axle if no ground engaging parts are present). As shown, the vehicle wheel base 138a may be considered the distance between the front axle 110a and the rear axle 110b of the work vehicle 102. The vehicle GPS offset distance 138b may be considered the distance between the center of the work vehicle 102 and the location of one or more of the reference vehicle kinematic sensors 126, particularly the GPS receiver of sensors 126, which in some instances, may be used to modify the one or more of the other dimensions. The hitch length 138c may be considered the distance between the center of the vehicle 102 and the end of the hitch 124, which is considered the connection point between the vehicle 102 and the drawbar 130 of the implement 104. The drawbar length 138d may be considered as the distance from the connection point with the hitch 124, along the drawbar 130, to the connection between the implement 104 and the drawbar 130. The machine distance 138e may be considered as the distance between the centers of the implement 104 and vehicle 102. The implement distance 138f may be considered as the distance between the vehicle at the implement connection point and the center of the implement 104. The implement connection point distance 138g may be considered as the distance between the implement center and a connection point between the drawbar 130 and the other portions of the implement 104. In this example, it is noted that the implement sensors 136 are located on the center of the implement 104; however, if the sensors 136, particularly a GPS receiver is at a different position, the system 128 may consider an offset distance between the sensors 136 and the center of the implement 104. Generally, the parameters may be defined in any suitable manner, including based on the particular configuration of the work machine 100. Further parameters depicted in FIG. 1 include the vehicle longitudinal axis 138h, the drawbar longitudinal axis 138i, and the implement longitudinal axis 138j.

Aspects of the reverse passive implement guidance system 128 may be characterized with reference to the implement lateral axis 134, as depicted in FIG. 1. In some examples, the work implement lateral axis 134 may be coincident with or parallel to the axles of the work implement 104. Although the examples discussed herein primary reference an implement 104 with a single axle, the discussion herein is also applicable to other types of implements, including those with more than one axle or no axles.

As introduced above, the reverse passive implement guidance system 128 operates to generate steering commands to maintain and/or return to a desired path (e.g., such as path 140 schematically depicted in FIG. 1) for the implement 104. Generally, the path 140 may be determined and/or stored by the controller 116 in any suitable manner. For example, the path 140 may be inputted by an operator via the operator interface 120, recorded by the controller 116 during a previous operation for reproduction during a current operation, and/or determined in real time by the controller 116 based on any suitable parameter (e.g., obstacles, row markers, visual identification of crops or other work materials, etc.). In any event, the controller 116 may store and execute a predetermined desired path for maneuvering the implement 104.

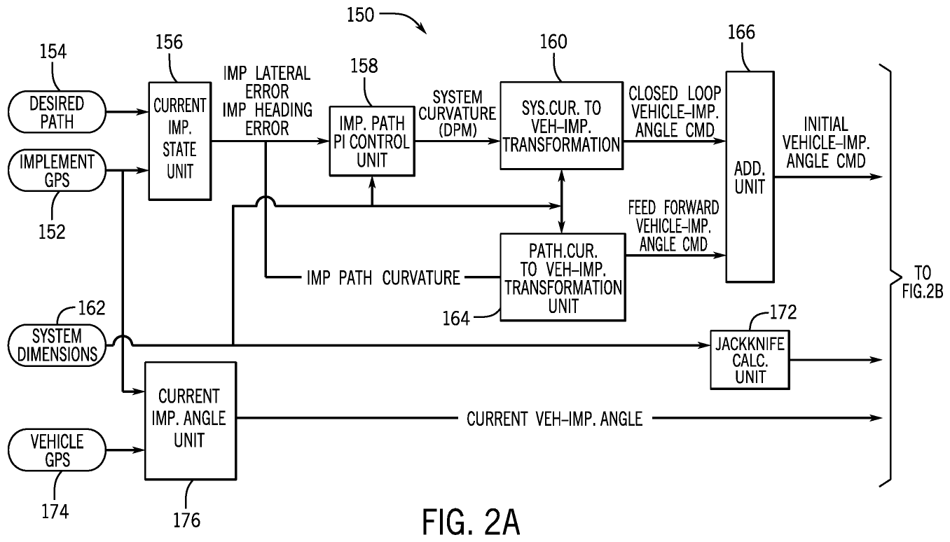

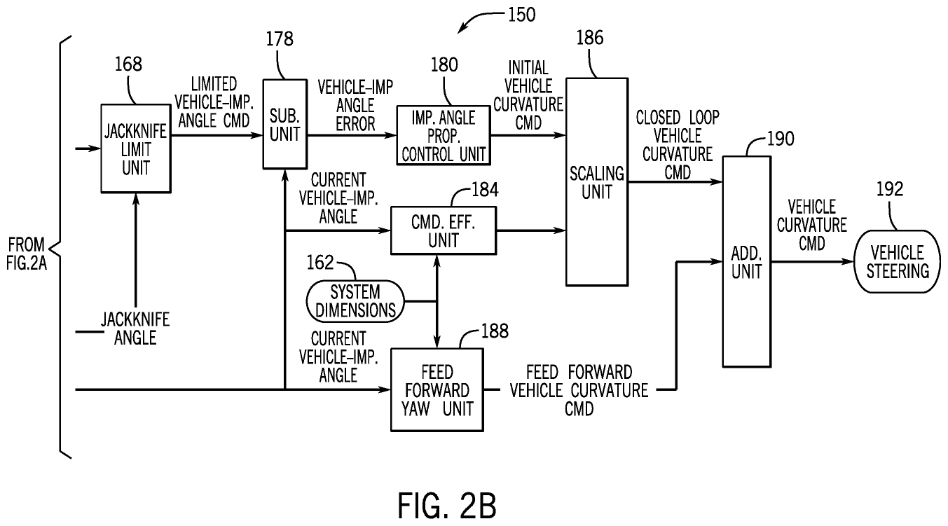

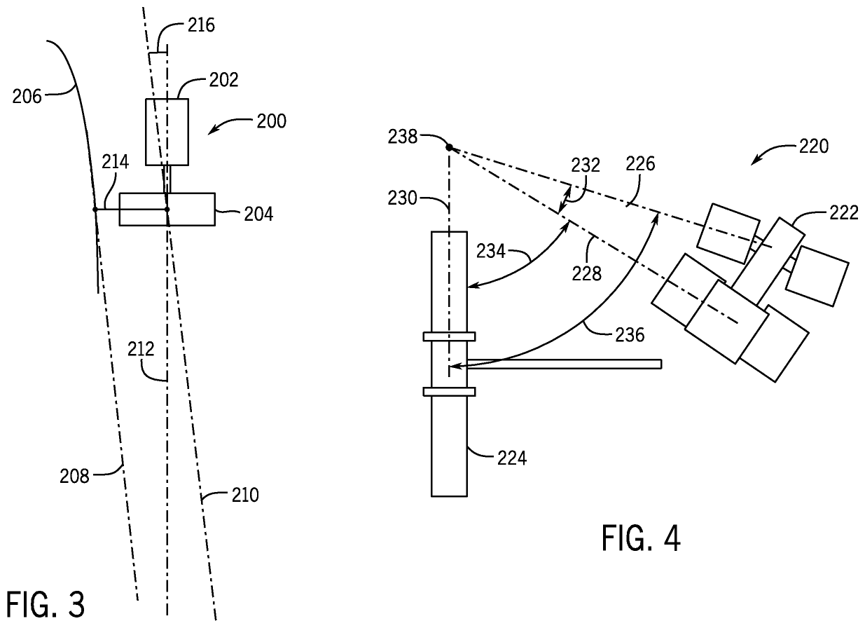

A more detailed discussion of the reverse passive implement guidance system 128 is provided below with reference with to FIGS. 2A, 2B, 3, and 4. In particular, FIGS. 2A and 2B depict a flowchart 150 of a method or implementation of operation of the reverse passive implement guidance system 128; and FIGS. 3 and 4 are schematic representations of aspects or conditions associated with the reverse passive implement guidance system 128.

Referring initially to FIGS. 2A and 2B, aspects of the reverse passive implement guidance system 128 may be organized within the controller 116 as one or more functional subsystems, units, or modules 152-192 (e.g., software, hardware, or combinations thereof), as discussed in greater detail below. As can be appreciated, the subsystems, units, or modules 152-192 shown in FIGS. 2A and 2B may be combined and/or further partitioned to carry out similar functions to those described herein.

Generally, as indicated by the portion of the flowchart 150 depicted in FIG. 2A, the reverse passive implement guidance system 128 receives inputs from a number of functional elements or sources 152, 154, 162, 174. In particular, the implement GPS (or kinematic) element 152 collects, retrieves, or otherwise determines the various kinematic parameters of the implement 104 (e.g., from implement kinematic sensors 136), including one or more of implement positions and/or orientations (e.g., direction, altitude, etc.), implement attitudes (e.g., pitch, roll, yaw), implement rates (e.g., speed, yaw rate), and/or angular positions or rates. Similarly, the vehicle GPS (or kinematic) element 174 collects, retrieves, or otherwise determines the various kinematic parameters of the vehicle 102 (e.g., from vehicle kinematic sensors 126), including one or more of vehicle positions and/or orientations (e.g., direction, altitude, etc.), vehicle attitudes (e.g., pitch, roll, yaw), vehicle rates (e.g., speed, yaw rate), and/or angular positions or rates. The desired path element 154 retrieves and/or determines the desired path of the work machine 100, particularly the implement 104. As noted above, the desired path may be determined by the controller 116 in any suitable manner, including storing a predetermined path provided by the operator, recorded from a previous work situation, and/or mapped by the controller 116. Finally, the system dimensions element 162 retrieve the various physical and functional parameters of the work machine 100. System dimension parameters may include the parameters discussed above with reference to FIG. 1, including vehicle wheel base 138a, vehicle GPS offset distance 138b, hitch length 138c, drawbar length 138d, machine distance 138e, implement distance 138f, and/or implement connection point distance 138g. Although depicted as being provided to units 158, 160, 164, 172, 184, 188, the system dimension parameters may be provided to any of the units or elements discussed below in order to generate the necessary or desired output. Moreover, such input data may also come in from other systems or controllers, either internal or external to the work vehicle 102. This input data may represent any data sufficient to operate and/or manipulate the work vehicle 102 and/or implement 104.

Moreover, the controller structure for implementing the reverse passive implement guidance system 128 depicted in the flowchart 150 of FIGS. 2A and 2B is merely one example of implementing such an operation. Other structures and mechanisms may be used. For example, while a PI control unit is discussed below as an example, any number of closed loop control mechanism designs may be used (e.g., state space, linear—quadratic regulator (LQR), and the like). Similarly, other units may have alternative structures or strategies for deriving a steering command to execute the reverse passive implement guidance according to the principles discussed herein.

Turning to the portion of the flowchart 150 in FIG. 2A, as shown, the implement GPS element 152 and the desired path element 154 respectively provide the kinematic parameters and the desired path to current implement state unit 156. In effect, the current implement state unit 156 evaluates the current position (e.g., based on the kinematic parameters) in view of the desired path to generate an implement lateral error and an implement heading error, and additionally evaluates the current path of the implement 104 to determine an implement path curvature.

An example of the error evaluations is provided by the schematic depiction of FIG. 3 in which a work machine 200 with a vehicle 202 is maneuvering an implement 204 that is not on the desired path 206. As shown, the implement lateral error 214 may be defined as the distance between the center of the implement 204 and the path 206; and the implement heading error 216 may be defined as the angle between a line 210 parallel to a tangent reference line 208 of the path 206 and a current implement heading line 210. Various transformations and conversions may occur with respect to data collection and/or evaluation. For example, for consideration of curved paths, a second order polynomial fit may be used to project smooth paths over the discrete intersections of segments. The implement lateral and heading errors are provided to an implement path proportional-integral (PI) control unit 158, discussed in greater detail below.

Returning to FIG. 2A, and as noted above, the current implement state unit 156 may also determine implement path curvature, although in some examples, the implement path curvature may be provided as part of the kinematic parameters. Generally, implement path curvature may be considered as the radius of curvature of the implement 104 at the current position along the current path, defined as the magnitude of the derivative of a unit tangent vector function with respect to arc length. The implement path curvature is provided to a path curvature to vehicle-implement transformation unit 164, discussed in greater detail below.

As noted, the implement lateral and heading errors are received by the implement path PI control unit 158, which operates to determine a system curvature command, e.g., referenced according to an overall curvature of the machine 100. Generally, the implement path PI control unit 158 uses a feedback control loop to evaluate the errors between the current and desired state of the implement and generates an appropriate correction. In one example, the correction generated by the implement path PI control unit 158 is in the form of a system curvature command. Generally, the implement path PI control unit 158 calculates the command based according to the following mechanism:
System Curvature Command=
Kₚ*Imp.Lat.Error+
Kᵢ*Imp.Lat.Error+
K_{pHead}*Imp.HeadingError
wherein, Kₚ, Kᵢ, and K_{pHead} are control gains.

The control gains may be tuned manually by an operator and/or a manufacturer, while in other examples, the control gains may be auto-tuned, such as by using root locus means or other optimal control mechanisms based on system dimensions and machine response rates. The implement path PI control unit 158 generates the curvature commands to drive the implement 104 towards the intended path 140, even when steady-state biases (e.g., side hill conditions or geometry mis-entry) are present.

The nature of system curvature is discussed with reference to FIG. 4, which is a schematic depicts of a work machine 220 having a vehicle 222 and an implement 224. In particular, the view of FIG. 4 schematically depicts the work machine 220 in a turn with reference lines 226, 228, 230 respectively extending perpendicularly from the front wheels of the vehicle 222, from the rear wheels of the vehicle 222 (which for unsteered wheels, is coincident with the rear axle), and from the wheels of the implement 224. The reference lines 226, 228, 230 converge at point 238, thereby indicating a stable system for the determination of system curvature. The schematic depiction of FIG. 4 also depicts the vehicle wheel angle 232, which is the angular difference between the vehicle front wheels (indicated by line 226) and the vehicle rear wheels (indicated by line 228), and the vehicle rear wheel-implement angle 234, which is the angular difference between the vehicle rear wheels (indicated by line 228) and the implement (indicated by line 230). Upon confirmation of a stable system, a system curvature 236 may be represented by the angular difference between the vehicle front wheels (indicated by line 226) and the implement (represented by line 230). If the machine 220 is not in stable system (e.g., the three reference lines 226, 228, 230 do not converge), the implement path PI control unit 158 may generate commands to transition the machine 220 into a suitable stable position prior to continuing with the reverse passive implement guidance operation.

In any event, and returning to FIGS. 1 and 2A, the implement path PI control unit 158 generates a system curvature command in the form of degrees per meter (or other suitable unit) based on the implement lateral and heading errors, as well as the system dimensions, as part of the process to maneuver the implement 104 onto the desired path.

As noted, the system curvature command from the implement path PI control unit 158 is provided to a system curvature to vehicle-implement transformation unit 160, which functions to generate a vehicle-implement angle command. An example depiction of a vehicle-implement angle is angle 234 of FIG. 4. In FIG. 2A, the system curvature to vehicle-implement transformation performed by the system curvature to vehicle-implement transformation unit 160 is effectively a trigonometric transformation in which the system curvature command is converted into the vehicle-implement angle command as a function of the system dimensions, in particular, one or more of the hitch length 138c, drawbar length 138d, machine distance 138e, implement distance 138f, and/or implement connection point distance 138g. Due to the nature of the system curvature command from the implement path PI control unit 158, the vehicle-implement angle command generated by the system curvature to vehicle-implement transformation unit 160 may be considered a “closed loop” vehicle-implement angle command provided to an addition unit 166, discussed in greater detail below.

As noted above, the implement path curvature is generated by the current implement state unit 156 and may be received by a path curvature to vehicle-implement transformation unit 164. The path curvature to vehicle-implement transformation unit 164 functions to transform the implement path curvature into a further vehicle-implement angle command. In particular, the current implement state unit 156 uses polynomial-based path curvature with two reference points: the current position of the implement 104 and a tuned distance in advance of the current position, thereby introducing an additional lead into the control mechanism. As such, due to the nature of the evaluation of the implement path curvature, the further feed forward vehicle-implement angle command generated by the path curvature to vehicle-implement transformation unit 164 may be considered a “feed forward” vehicle-implement angle command.

An addition (or first addition) unit 166 receives and adds the closed loop vehicle-implement angle command and the feed froward vehicle-implement angle command to generate an initial vehicle-implement angle command. In effect, the closed loop vehicle-implement angle command is associated with the current path or state characteristics, which may appear to the system 128 as a straight line, and the feed froward vehicle-implement angle command is associated with the future path or state characteristics, which incorporates the possibility of a curved path. As a result, a combination of the two types of vehicle-implement commands may provide a more accurate or appropriate vehicle-implement command. Due to the subsequent modifications and limits, the vehicle-implement command provided by the addition unit 166 may be referred to as a “initial” vehicle-implement angle command, which is discussed in greater detail below with reference to FIG. 2B.

Still referring to FIG. 2A, the current implement angle unit 176 receives the implement kinematic parameters from the implement GPS element 152 and the vehicle kinematic parameters from the vehicle GPS element 174. An example depiction of a vehicle-implement angle is angle 234 of FIG. 4. In FIG. 2A, from these parameters, the current implement angle unit 176 may derive the current implement angle, discussed in greater detail below.

Additionally, the system dimensions from the system dimensions element 162 may be considered by a jackknife calculation unit 172, which operates to determine the angle at which a jackknife condition may occur. Typically, a jackknife condition is one in which the angle between the implement 104 and the vehicle 102 is too large such that it is difficult to recover. Additionally, in this instance, the jackknife condition may refer to the vehicle 102 tires contacting (or “running over”) the drawbar 130 and/or implement 104. In any event, the value of such an angle (as a “jackknife angle”) may be derived from the dimensions of the work machine 100. The jackknife calculation unit 172 determines the jackknife angle based on trigonometric relationships of the system dimensions, in particular, one or more of vehicle wheel base 138a, vehicle GPS offset distance 138b, hitch length 138c, drawbar length 138d, machine distance 138e, implement distance 138f, and/or implement connection point distance 138g (as well as, optionally, a maximum steering angle).

Referring now to FIG. 2B, a jackknife limit unit 168 receives the initial vehicle-implement angle command (e.g., from the addition unit 166 of FIG. 2A) and the jackknife angle (e.g., from the jackknife calculation unit 172). In response, the jackknife limit unit 168 limits the initial vehicle-implement command to a value that will not result in a jackknife condition. The resulting limited vehicle-implement angle command may be provided to a subtraction unit 178.

The subtraction unit 178 receives the current vehicle-implement angle (e.g., from the current implement angle unit 176 of FIG. 2A) and the limited vehicle-implement angle command, and in response, generates a vehicle-implement angle error, which represents the difference between the current angle and the desired or commanded angle. The vehicle-implement angle error is provided to an implement angle proportional control unit180.

The implement angle proportional control unit 180 receives the vehicle-implement angle error, and in response, generates an initial vehicle curvature command. In effect, the implement angle proportional control unit 180 is an “inner loop” of a cascaded control loop design of the flowchart 150. The implement angle proportional control unit 180 considers the vehicle-implement angle error and functions to increase or decrease the steering command in proportion to the amount of error in order to bring the implement angle error to zero. Since the implement angle is a function of time, speed, and vehicle steering angle, the closed loop control enables a more appropriate determination of the initial vehicle curvature command. The initial vehicle curvature command is provided to a scaling unit 186.

A command efficacy unit 184 receives the current vehicle-implement angle (e.g., from the current implement angle unit 176 of FIG. 2A) and the system dimension (e.g., from the system dimensions element 162), and in response, generates an efficacy value. Generally, the efficacy value generated by the command efficacy unit 184 attempts to normalize, linearize, and/or optimize the responsiveness of the steering system 112 on the relative yaw rate between the vehicle 102 and the implement 104 (e.g., effectively, a system steering rate) with respect to a given command. For example, a one (1) dpm vehicle curvature change results in a greater relative yaw rate change between the vehicle 102 and implement 104 at low vehicle-implement angles as compared to higher vehicle-implement angles. In order to achieve such linearization of the steering commands relative to vehicle-implement angles, kinematic parameters (particularly, velocities) may be calculated for a particular set of dimensional parameters and implement angles; and the effective relative yaw may be determined, thereby enabling the creation of an efficacy value to function as a command scalar for application to a steering command. The efficacy value is provided to the scaling unit 186.

The scaling unit 186 receives the initial vehicle curvature command from the implement angle proportional control unit 180 and the efficacy value from the command efficacy unit 184, and in response, generates a vehicle curvature command. In effect, vehicle curvature command is “scaled” by the efficacy value in order to provide a more effective subsequent steering command. Due to the nature of the proportional control unit 180, the resulting vehicle curvature command generated by the scaling unit 186 may be considered a “closed loop” vehicle curvature command, which is provided to an addition (or second addition) unit 190.

A feed forward yaw unit 188 receives the current vehicle-implement angle (e.g., from the current implement angle unit 176 of FIG. 2A) and the system dimension (e.g., from the system dimensions element 162), and in response, generates a vehicle curvature command. Generally, the feed forward yaw unit 188 determines the required vehicle steering angle at a current implement angle to maintain the current implement angle, thereby providing a zero relative yaw rate between the vehicle 102 and the implement 104. The feed forward yaw unit 188 operates to transform the current vehicle-implement angle into a steady state vehicle curvature command via a trigonometric conversion as a function of system dimensions, in particular, one or more of the hitch length 138c, drawbar length 138d, machine distance 138e, implement distance 138f, and/or implement connection point distance 138g. Due the nature of the feed forward yaw unit 188, the resulting vehicle curvature command may be considered a “feed forward” vehicle curvature command. The feed forward vehicle curvature command is provided to the addition unit 190.

The addition unit 190 receives the closed loop vehicle curvature command from the scaling unit 186 and the feed forward vehicle curvature command from the feed forward yaw unit 188, and in response, generates a vehicle curvature command. As noted, feed forward vehicle curvature command from the feed forward yaw unit 188 enables the maintenance of a zero relative yaw rate between the vehicle 102 and the implement 104. In effect, the feed forward yaw unit 188 enables the closed loop vehicle curvature commands from the scaling unit 186 to be centered on a stable command instead of a command from an aligned vehicle 102 and implement 104.

The vehicle curvature command is provided to a vehicle steering element 192 for implementation (e.g., via the steering system 112 of FIG. 1). In particular, based on this command, steering system 112 operates to steer the vehicle 102 such that the implement 104 is directed to the desired path. Subsequently, operation according to the flowchart of FIGS. 2A and 2B is repeated to in attempt to follow or maintain a desired path.

Accordingly, the present disclosure provides a reverse passive implement guidance system and method for a work vehicle. Such systems and methods provide improved, more efficient operation, and more accurate operation.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the work vehicles and the control systems and methods described herein are merely exemplary embodiments of the present disclosure.

Conventional techniques related to signal processing, data transmission, signaling, control, and other functional aspects of the systems (and the individual operating components of the systems) may not be described in detail herein for brevity. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Any suitable computer usable or computer readable medium may be utilized. The computer usable medium may be a computer readable signal medium or a computer readable storage medium. A computer-usable, or computer-readable, storage medium (including a storage device associated with a computing device or client electronic device) may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that may contain, or store a program for use by or in connection with the instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be non-transitory and may be any computer readable medium that is not a computer readable storage medium and that may communicate, propagate, or transport a program for use by or in connection with an instruction execution system, apparatus, or device.

Aspects of certain embodiments are described herein may be described with reference to flowchart illustrations and/or block diagrams of methods, apparatus (systems) and computer program products according to embodiments of the invention. It will be understood that each block of any such flowchart illustrations and/or block diagrams, and combinations of blocks in such flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

It is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Terms of degree, such as “substantially,” “about,” “approximately,” etc. are understood by those of ordinary skill to refer to reasonable ranges outside of the given value, for example, general tolerances associated with manufacturing, assembly, and use of the described embodiments.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A reverse passive implement guidance system for a work machine having a work vehicle configured to direct an implement coupled to the work vehicle via a steering system of the work vehicle along a desired implement path, the reverse passive implement guidance system comprising:
one or more vehicle sensors mounted on the work vehicle to collect vehicle position and orientation information associated with the work vehicle;
one or more implement sensors mounted on the implement to collect implement position and orientation information associated with the implement; and
a controller coupled to the one or more vehicle sensors and the one or more implement sensors, the controller having a processor and memory architecture configured to:
receive the vehicle position and orientation information and the implement position and orientation;
generate vehicle steering commands based on vehicle position and orientation information and the implement position and orientation to drive the work vehicle such the implement is guided in a reverse direction onto or along the desired implement path; and
execute the vehicle steering commands via the steering system of the work vehicle.

2. The reverse passive implement guidance system of claim 1, wherein the controller is configured to generate the vehicle steering commands based on a system curvature of the work machine.

3. The reverse passive implement guidance system of claim 1, wherein the controller is configured to generate the vehicle steering commands with closed loop and feed forward control mechanisms.

4. The reverse passive implement guidance system of claim 1, wherein the controller is configured to generate the vehicle steering commands with a machine efficacy value.

5. The reverse passive implement guidance system of claim 1, wherein the controller is configured to generate the vehicle steering commands limited according to a jackknife angle.

6. The reverse passive implement guidance system of claim 1, wherein the controller is configured to generate the vehicle steering commands based on a system curvature of the work machine in which the system curvature is defined as a curvature between a front vehicle wheel reference line and an implement reference line within a stable system.

7. The reverse passive implement guidance system of claim 6, wherein the controller is configured to generate the vehicle steering commands by generating a system curvature command based on implement lateral and heading errors.

8. The reverse passive implement guidance system of claim 7, wherein the controller is configured to generate the vehicle steering commands further by:
transforming the system curvature command into a first vehicle-implement angle command as a closed loop control mechanism;
determining an implement path curvature and transforming the implement path curvature into a second vehicle-implement angle command as a feed forward control mechanism; and
combining the first vehicle-implement angle command and the second vehicle-implement angle command to generate an initial vehicle-implement angle command.

9. The reverse passive implement guidance system of claim 8, wherein the controller is configured to generate the vehicle steering commands further by limiting the initial vehicle-implement angle command by a jackknife angle to generate a limited vehicle-implement angle command.

10. The reverse passive implement guidance system of claim 9, wherein the controller is configured to generate the vehicle steering commands further by:
subtracting a current vehicle-implement angle from the limited vehicle-implement angle command to generate a vehicle-implement angle error;
transforming the vehicle-implement angle error into an initial vehicle curvature command;
scaling the initial vehicle curvature command by application of an efficacy value to generate a closed loop vehicle curvature command;
transforming the current implement angle into a feed forward vehicle curvature command by maintaining a zero relative yaw rate; and
combining the closed loop vehicle curvature command and the feed forward vehicle curvature command to generate a final vehicle curvature command that is executed as the steering commands.

11. A work machine, comprising:
a work vehicle having a steering system;
an implement coupled to the work vehicle and configured to be manipulated by the work vehicle; and
a reverse passive implement guidance system for the work vehicle configured to direct the implement via the steering system of the work vehicle along a desired implement path, the reverse passive implement guidance system comprising:
one or more vehicle sensors mounted on the work vehicle to collect vehicle position and orientation information associated with the work vehicle;
one or more implement sensors mounted on the implement to collect implement position and orientation information associated with the implement; and
a controller coupled to the one or more vehicle sensors and the one or more implement sensors, the controller having a processor and memory architecture configured to:
receive the vehicle position and orientation information and the implement position and orientation;
generate vehicle steering commands based on vehicle position and orientation information and the implement position and orientation to drive the work vehicle such the implement is guided in a reverse direction onto or along the desired implement path; and
execute the vehicle steering commands via the steering system of the work vehicle.

12. The work machine of claim 11, wherein the controller of the reverse passive implement guidance system is configured to generate the vehicle steering commands based on a system curvature of the work machine.

13. The work machine of claim 11, wherein the controller of the reverse passive implement guidance system is configured to generate the vehicle steering commands with closed loop and feed forward control mechanisms.

14. The work machine of claim 11, wherein the controller of the reverse passive implement guidance system is configured to generate the vehicle steering commands with a machine efficacy value.

15. The work machine of claim 11, wherein the controller of the reverse passive implement guidance system is configured to generate the vehicle steering commands limited according to a jackknife angle.

16. The work machine of claim 11, wherein the controller of the reverse passive implement guidance system is configured to generate the vehicle steering commands based on a system curvature of the work machine in which the system curvature is defined as a curvature between a front vehicle wheel reference line and an implement reference line within a stable system.

17. The work machine of claim 16, wherein the controller of the reverse passive implement guidance system is configured to generate the vehicle steering commands by generating a system curvature command based on implement lateral and heading errors.

18. The work machine of claim 17, wherein the controller of the reverse passive implement guidance system is configured to generate the vehicle steering commands further by:
transforming the system curvature command into a first vehicle-implement angle command as a closed loop control mechanism;
determining an implement path curvature and transforming the implement path curvature into a second vehicle-implement angle command as a feed forward control mechanism; and
combining the first vehicle-implement angle command and the second vehicle-implement angle command to generate an initial vehicle-implement angle command.

19. The work machine of claim 18, wherein the controller of the reverse passive implement guidance system is configured to generate the vehicle steering commands further by limiting the initial vehicle-implement angle command by a jackknife angle to generate a limited vehicle-implement angle command.

20. The work machine of claim 19, wherein the controller of the reverse passive implement guidance system is configured to generate the vehicle steering commands further by:
subtracting a current vehicle-implement angle from the limited vehicle-implement angle command to generate a vehicle-implement angle error;
transforming the vehicle-implement angle error into an initial vehicle curvature command;
scaling the initial vehicle curvature command by application of an efficacy value to generate a closed loop vehicle curvature command;
transforming the current implement angle into a feed forward vehicle curvature command by maintaining a zero relative yaw rate; and
combining the closed loop vehicle curvature command and the feed forward vehicle curvature command to generate a final vehicle curvature command that is executed as the steering commands.
